(19) United States
(12) Patent Application Publication
(10) Pub. No.: US 2013/0286939 A1
(43) Pub. Date: Oct. 31, 2013

(54) ELECTRONIC DEVICE AND METHOD FOR MANAGING PACKET TRANSMISSION

(71) Applicant: CHI MEI COMMUNICATION SYSTEMS, INC., New Taipei (TW)

(72) Inventor: WEI-YING HUANG, New Taipei (TW)

(73) Assignee: CHI MEI COMMUNICATION SYSTEMS, INC., New Taipei (TW)

(21) Appl. No.: 13/864,284

(22) Filed: Apr. 17, 2013

(30) Foreign Application Priority Data
Apr. 25, 2012 (TW) 101114617

(51) Int. Cl. H04W 40/24

(52) U.S. Cl. CPC H04W 40/24
USPC 370/328

(57) ABSTRACT

In a method for managing packet transmission using an electronic device, a refreshed application sends refreshed packets to a wireless base station is determined when the electronic device is in a connected state with the wireless base station. When the electronic device receives a disconnection signal, the method determined whether the disconnection signal is a result of a disconnection operation performed by a user on the electronic device. When the disconnection signal is not the result of the disconnection operation, the method further controls the electronic device to attempt to reconnect to the wireless base station and not to send any disconnection information to the refreshed application within a predetermined time period, when the electronic device does not receive any communication signal.

### BACKGROUND

1. Technical Field

Embodiments of the present disclosure relate to network technology, and particularly to an electronic device and method for managing packet transmission using the electronic device. 2. Description of Related Art

When an electronic device (e.g., a mobile phone) establishes a connection with a wireless base station, one or more applications (e.g., an email application) in the electronic device may send data packets (e.g., refresh packets) to the wireless base station using a modem of the electronic device. When the electronic device loses communication signals (e.g., mobile phone signals), and is disconnected from the wireless base station, the modem sends disconnection information to the one or more applications through a plurality of layers (e.g., a telephony framework layer and a radio interface layer) of the electronic device. After the electronic device reacquires communication signals and is reconnected from the wireless base station, the modem sends reconnection information to the one or more applications, then the one or more applications sends the same data packets (e.g., the refresh packets) to the wireless base station again.

However, the electronic device may be disconnected from the wireless base station because the electronic device loses the communication signals temporarily. Thus, the above solution sends the same data packets to the wireless base stations every time that the electronic device reacquires the interrupted communication signals within a short time period. For example, when the electronic device is located in a place where the communication signals received by the electronic device are unstable, many needless same data packets of the applications are repeatedly sent to the wireless base station.

Accordingly, system resources of the electronic device and the wireless base station are wasted by using the above solution. Therefore, an efficient method for managing packet transmission using the electronic device is desired.

### BRIEF DESCRIPTION OF THE DRAWINGS

FIG. 1 is a block diagram of one embodiment of an electronic device including a controlling system.

FIG. 2 is a block diagram of function modules of the controlling system in the electronic device.

FIG. 3 is a block diagram of one embodiment of a relationship between multiple layers of the electronic device.

FIG. 4 is a flowchart of one embodiment of a method for managing packet transmission using the controlling system.

FIG. 5 is a flowchart of step S12 in the flowchart of FIG. 4.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

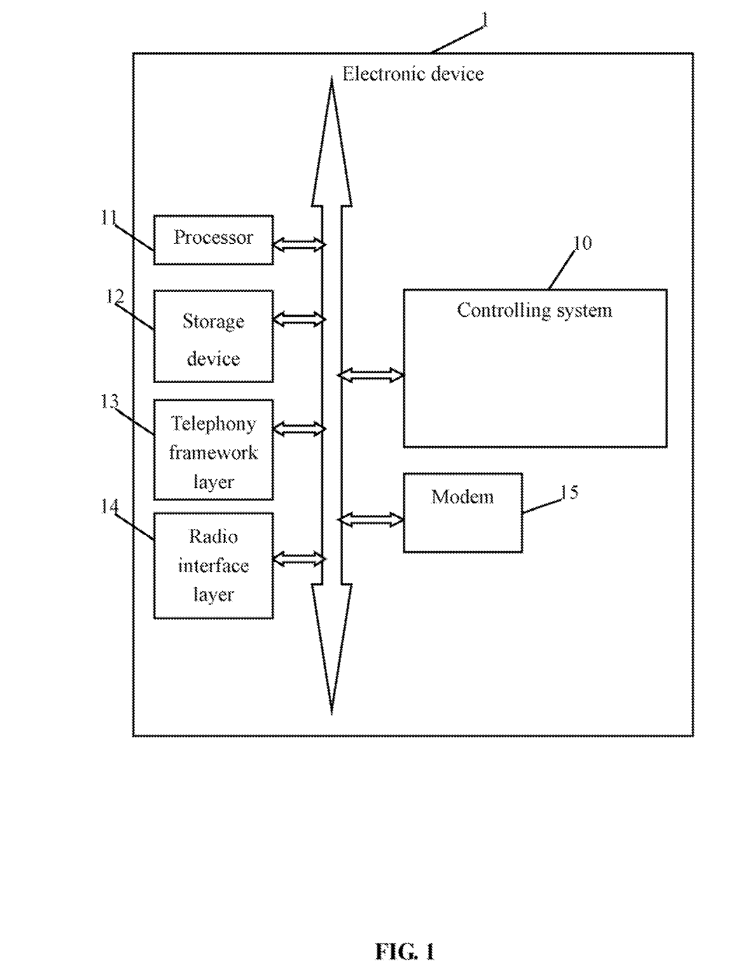

FIG. 1 is a block diagram of one embodiment of an electronic device 1 including a controlling system 10. The electronic device 1 further includes at least one processor 11, a storage device 12, a telephony framework layer 13, a radio interface layer 14 (RIL), and a modem 15. FIG. 1 illustrates only one example of the electronic device 1, in other examples, the electronic device 1 may include more or fewer components than illustrated, or have a different configuration of the various components in other embodiments.

The controlling system 10 determines whether the electronic device 1 receives communication signals (e.g., mobile/cell phone signals) when the electronic device 1 is disconnected from a wireless base station, and controls the electronic device 1 not to send disconnection information to applications in the electronic device 1 within a predetermined time period, therefore avoiding repeatedly sending same data packets (e.g., refresh packets) to the wireless base station from the applications when the electronic device 1 reacquires the communication signals within the predetermined time period (e.g., 2 seconds). A detailed description of the controlling system 10 will be given in the following paragraphs.

In one embodiment, the electronic device 1 may be a mobile phone, a tablet computer, a personal digital assistant, a notebook computer, or other device. In one embodiment, the controlling system 10 includes computerized instructions in the form of one or more programs that are executed by the at least one processor 11 and stored in the storage device 12. The storage device 12 stores one or more programs, such as operating systems, applications of the electronic device 1, and various kinds of data, such as images. In some embodiments, the storage device 12 may be an external storage card, such as a memory stick, a smart media card, a compact flash card, a secure digital card, or any other type of memory storage device.

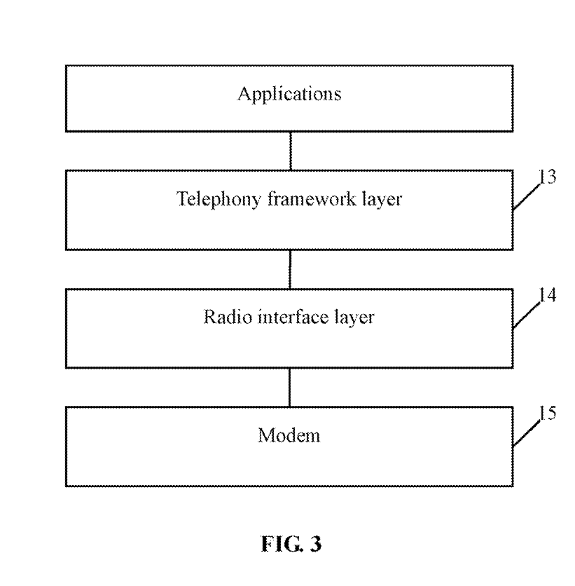

A relationship between the telephony framework layer 13, the RIL 14, and the modem 15 is shown in FIG. 3. The telephony framework layer 13, the RIL 14, and the modem 15 may exchange data between themselves for executing specified commands

For example, when the electronic device 1 is disconnected from the wireless base station, the modem 15 may transmit disconnection information to applications of the electronic device 1 through the RIL 14 and the telephony framework layer 13 as shown in FIG. 3.

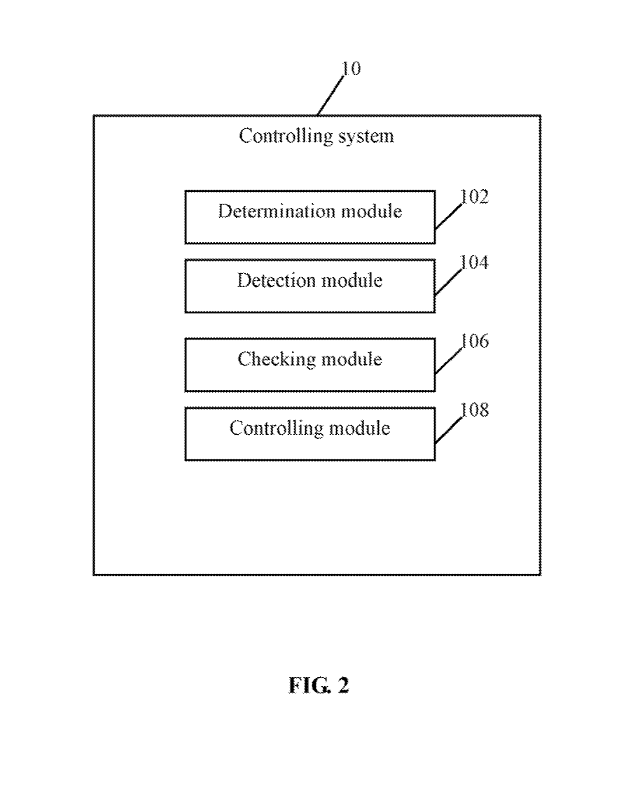

FIG. 2 is a block diagram of function modules of the controlling system 10 included in the electronic device 1. In one embodiment, the controlling system 10 may include one or more modules, for example, a determination module 102, a detection module 104, a checking module 106, and a controlling module 108. In general, the word “module,” as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

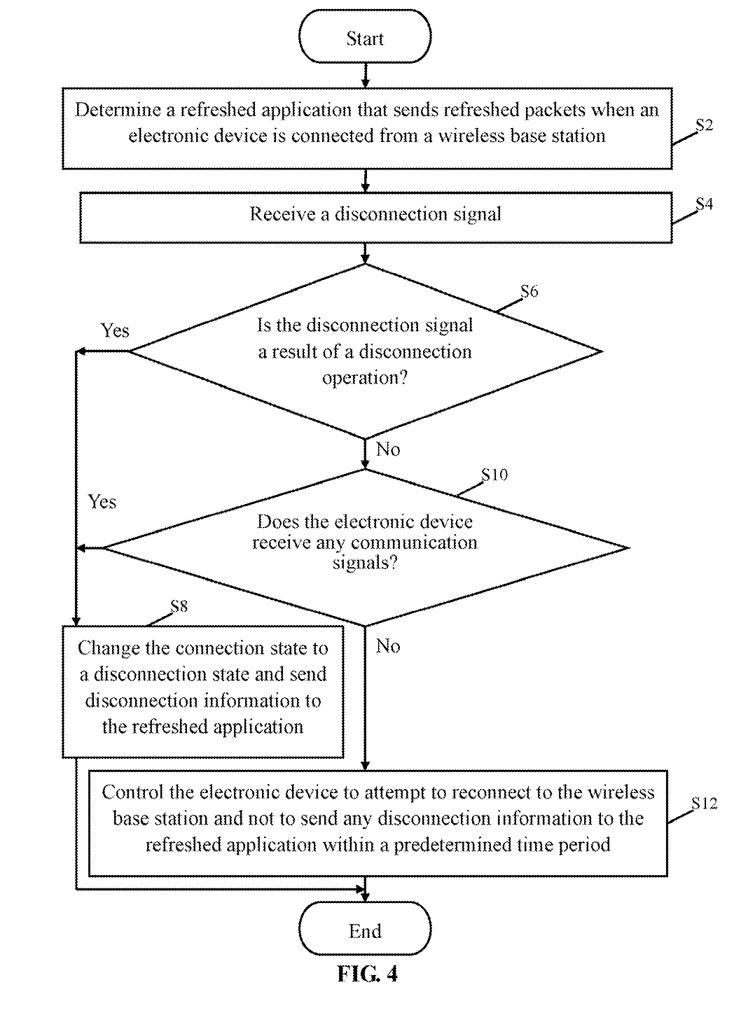

FIG. 4 is a flowchart of one embodiment of a method for managing packet transmission using the controlling system 10. Depending on the embodiment, additional steps may be added, others removed, and the ordering of the steps may be changed.

In step S2, the determination module 102 determines one or more applications that send refreshed packets to the wireless base station when the electronic device 1 is connected from the wireless base station, and determines the one or more applications as refreshed applications.

For example, every time that the electronic device 1 is connected from the wireless base station, the refreshed applications in the electronic device 1 send refreshed packets to a network server of a provider through the connection between the electronic device 1 and the wireless base station, so as to refresh data of the applications. For another example, an email application in the electronic device 1 may send refreshed packets to an email server for refreshing an inbox of email messages received by the electronic device 1 through the above mentioned connection. That is, such an email application is determined to be the refreshed application.

One refreshed application is determined as follows.

In step S4, the detection module 104 detects a disconnection signal received by the electronic device 1. In some embodiments, when a disconnection between the electronic device 1 and the wireless base station occurs, the disconnection causes the modem 15 to issue a disconnection signal, which is sent to the telephony framework layer 13 using the modem 15, and the disconnection signal is then received by the detection module 104.

In step S6, the detection module 104 detects whether the disconnection signal is a result of a disconnection operation performed by a user of the electronic device 1. In some embodiments, the detection module 104 detects whether the disconnection signal is the result of the disconnection operation performed by the user, by detecting operation signals on the electronic device 1 in response to the disconnection operation performed by the user.

For example, when the detection module 104 detects the operation signals, the detection module 104 determines that the disconnection operation has been performed by the user on the electronic device 1, and the disconnection signal is the result of the disconnection operation, then the procedure goes to step S8.

When the detection module 104 detects no operation signals, the detection module 104 determines that no disconnection operation has been performed by the user on the electronic device 1, and the disconnection signal is not the result of the disconnection operation, then the procedure goes to step S10.

In step S8, the controlling module 108 changes the connected state of the electronic device 1 to a disconnected state, and sends disconnection information to the refreshed applications through the RIL 14 and the telephony framework layer 13. Thus, when the electronic device 1 is reconnected from the wireless base station because of a connection operation or a reconnection operation of the user, the modem 15 of the electronic device 1 sends the refreshed packets of the refreshed applications to the wireless base station.

In step S10, the checking module 106 checks whether the electronic device 1 receives any communication signals (e.g., mobile phone communication signals). If the electronic device 1 receives the communication signals, the procedure goes to step S8. If the electronic device 1 does not receive any communication signals, the procedure goes to step S12.

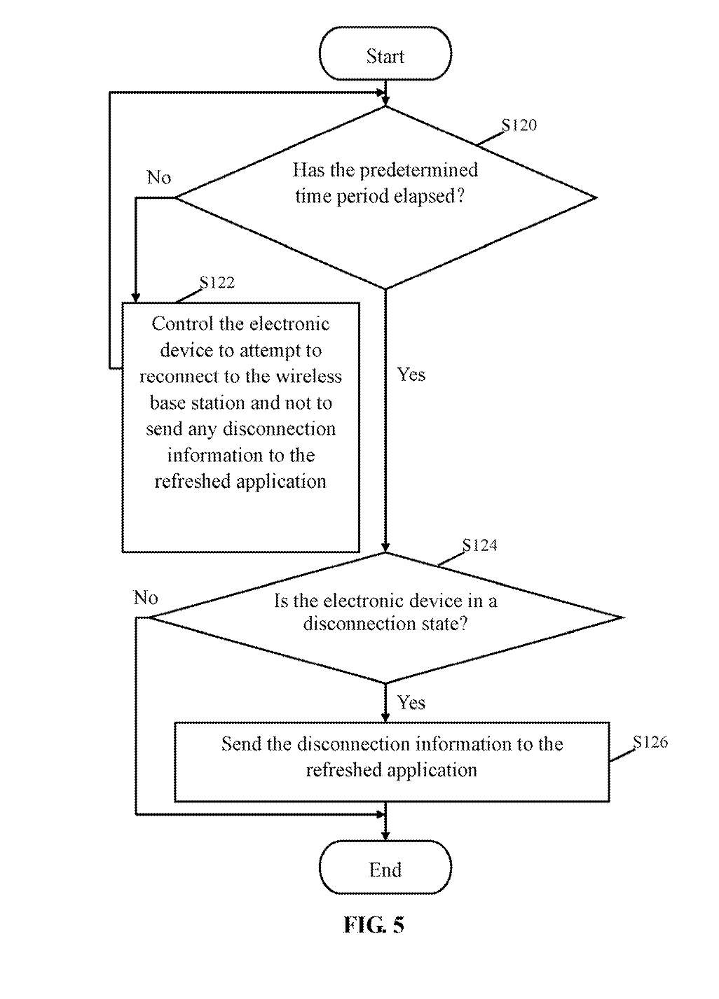

In step S12, the controlling module 108 controls the electronic device 1 to attempt to reconnect to the wireless base station within a predetermined time period (e.g., 2 seconds), and controls the electronic device 1 not to send any disconnection information to the refreshed applications during the predetermined time period. In some embodiments, the predetermined time period is used as a period for the electronic device 1 to attempt to reacquire the communication signals and reconnected from the wireless base station, thereby reducing a number of the refreshed packets that may be sent to the wireless base station. A detailed procedure of step S12 is provided in FIG. 5.

In other embodiments, the controlling module 108 determines and records connection state of the electronic device 1. The connection state may include, but is not limited to, a connected state and a disconnected state. For example, when the electronic device 1 is connected from the wireless base station, the controlling module 108 determines and records that the electronic device 1 is in the connected state. Otherwise, when the electronic device 1 is disconnected from the wireless base station, the controlling module 108 determines and records that the electronic device 1 is in the disconnected state.

In other embodiments, the controlling module 108 further checks whether the electronic device 1 receives the communication signals when the electronic device 1 receives a service change notice, and records a current connection state of the electronic device 1. In some embodiments, the service change notice indicates a service state of the electronic device 1 has been changed, and the service state of the electronic device 1 may be a roaming state, for example.

FIG. 5 is a flowchart of step S12 in the flowchart of FIG. 4. Depending on the embodiment, additional steps may be added, others removed, and the ordering of the steps may be changed.

In step S120, the controlling module 108 determines whether the predetermined time period has elapsed. When the predetermined time period has not elapsed, the procedure goes to step S122. When the predetermined time period has elapsed, the procedure goes to step S124.

In step S122, the controlling module 108 controls the electronic device 1 to attempt to reconnect to the wireless base station, and controls the electronic device 1 not to send any disconnection information to the refreshed applications, then the procedure returns to step S120.

In step S124, the controlling module 108 determines whether the electronic device 1 is still in the disconnected state.

When the electronic device 1 is still in the disconnected state, in step S126, the controlling module 108 sends the disconnection information to the refreshed application. Afterwards, when the refreshed application receives the disconnection information, the controlling module 108 resends the refreshed packets of the refreshed application to the wireless base station using the modem 15.

When the electronic device 1 is not in the disconnected state, that is, the electronic device 1 is in the connected state, the procedure ends.

It should be emphasized that the above-described embodiments of the present disclosure, particularly, any embodiments, are merely possible examples of implementations, set forth for a clear understanding of the principles of the disclosure.

Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented method for managing packet transmission using an electronic device, the electronic device comprising at least one processor and applications, the method comprising:
determining a refreshed application that sends refreshed packets to a wireless base station when the electronic device is in a connected state with the wireless base station;
detecting, using the at least one processor, whether any disconnection operation is performed on the electronic device when the electronic device receives a disconnection signal;
determining that the disconnection signal is not a result of the disconnection operation when no disconnection operation is performed on the electronic device;
checking whether the electronic device receives any communication signal; and
controlling the electronic device to attempt to reconnect to the wireless base station within a predetermined time period, and controlling the electronic device not to send any disconnection information to the refreshed application during the predetermined time period, when the electronic device does not receive any communication signal.

2. The method according to claim 1, further comprising:
sending the disconnection information to the refreshed application when the electronic device is not reconnected from the wireless base station within the predetermined time period.

3. The method according to claim 2, further comprising:
resending the refreshed packets of the refreshed application to the wireless base station when the electronic device is reconnected from the wireless base station after the refreshed application receives the disconnection information.

4. The method according to claim 1, further comprising:
changing the connected state of the electronic device to a disconnected state, and sending the disconnection information to the refreshed application, when the disconnection operation is performed on the electronic device.

5. The method according to claim 1, further comprising:
changing the connected state of the electronic device to a disconnected state, and sending the disconnection information to the refreshed application, when the electronic device receives the communication signal.

6. The method according to claim 1, further comprising:
checking whether the electronic device receives any communication signal when the electronic device receives a service change notice that indicates a service state of the electronic device has been changed, and recording a current connection state of the electronic device.

7. An electronic device, comprising:
a storage device that stores applications;
at least one processor; and
one or more modules that are stored in the storage device and are executed by the at least one processor, the one or more modules comprising:
a determination module that determines a refreshed application that sends refreshed packets to a wireless base station when the electronic device is in a connected state with the wireless base station;
a detection module that detects whether any disconnection operation is performed on the electronic device when the electronic device receives a disconnection signal, and determines that the disconnection signal is not a result of the disconnection operation when no disconnection operation is performed on the electronic device;
a checking module that checks whether the electronic device receives any communication signal; and
a controlling module that controls the electronic device to attempt to reconnect to the wireless base station within a predetermined time period, and controlling the electronic device not to send any disconnection information to the refreshed application during the predetermined time period, when the electronic device does not receive any communication signal.

8. The electronic device according to claim 7, wherein the controlling module sends the disconnection information to the refreshed application when the electronic device is not reconnected from the wireless base station within the predetermined time period.

9. The electronic device according to claim 8, wherein the controlling module resends the refreshed packets of the refreshed application to the wireless base station when the electronic device is reconnected from the wireless base station after the refreshed application receives the disconnection information.

10. The electronic device according to claim 7, wherein the controlling module changes the connected state of the electronic device to a disconnected state and sends the disconnection information to the refreshed application, when the disconnection operation is performed on the electronic device.

11. The electronic device according to claim 7, wherein the controlling module changes the connected state of the electronic device to a disconnected state, and sends the disconnection information to the refreshed application, when the electronic device receives the communication signal.

12. The electronic device according to claim 7, wherein the controlling module checks whether the electronic device receives any communication signal when the electronic device receives a service change notice that indicates a service state of the electronic device has been changed, and recording a current connection state of the electronic device.

13. A non-transitory storage medium having stored thereon instructions that, when executed by a processor of an electronic device, causes the electronic device to perform a method for managing packet transmission using an electronic device, the electronic device comprising at least one processor and applications, the method comprising:
determining a refreshed application that sends refreshed packets to a wireless base station when the electronic device is in a connected state with the wireless base station;
detecting, using the at least one processor, whether any disconnection operation is performed on the electronic device when the electronic device receives a disconnection signal;
determining that the disconnection signal is not a result of the disconnection operation when no disconnection operation is performed on the electronic device;
checking whether the electronic device receives any communication signal; and
controlling the electronic device to attempt to reconnect to the wireless base station within a predetermined time period, and controlling the electronic device not to send any disconnection information to the refreshed application during the predetermined time period, when the electronic device does not receive any communication signal.

14. The non-transitory storage medium according to claim 13, wherein the method further comprises:
sending the disconnection information to the refreshed application when the electronic device is not reconnected from the wireless base station within the predetermined time period.

15. The non-transitory storage medium according to claim 14, wherein the method further comprises:
resending the refreshed packets of the refreshed application to the wireless base station when the electronic device is reconnected from the wireless base station after the refreshed application receives the disconnection information.

16. The non-transitory storage medium according to claim 13, wherein the method further comprises:
changing the connected state of the electronic device to a disconnected state, and sending the disconnection information to the refreshed application, when the disconnection operation is performed on the electronic device.

17. The non-transitory storage medium according to claim 13, wherein the method further comprises:
changing the connected state of the electronic device to a disconnected state, and sending the disconnection information to the refreshed application, when the electronic device receives the communication signal.

18. The non-transitory storage medium according to claim 13, wherein the method further comprises:
checking whether the electronic device receives any communication signal when the electronic device receives a service change notice that indicates a service state of the electronic device has been changed, and recording a current connection state of the electronic device.
